(19) United States
(12) Patent Application Publication
(10) Pub. No.: US 2025/0375916 A1
(43) Pub. Date: Dec. 11, 2025

(54) PREPARATION METHOD FOR RAW BAMBOO FIBER STRIPS AND PROCESSING MACHINE

(71) Applicant: JIYANG COLLEGE OF ZHEJIANG A&F UNIVERSITY, Zhuji (CN)

(72) Inventors: Wenbin YAO, Zhuji (CN); Chao ZHOU, Zhuji (CN); Weipeng YU, Zhuji (CN); Wei ZHANG, Zhuji (CN); Huawei WU, Zhuji (CN)

(21) Appl. No.: 19/019,226

(22) Filed: Jan. 13, 2025

(30) Foreign Application Priority Data
Jun. 11, 2024 (CN) 202410748688.5

(51) Int. Cl. B27J 1/00; B27C 5/06; D01C 1/02

(52) U.S. Cl. CPC B27J 1/00; B27C 5/06; D01C 1/02

(57) ABSTRACT

A preparation method for raw bamboo fiber strips and a processing machine are provided. The preparation method includes: cutting bamboo wood into bamboo tubes according to a length of each of bamboo joints, and cutting the bamboo tubes into bamboo pieces; processing the bamboo pieces into the bamboo fiber skins through a processing machine; performing fermentation treatment on the bamboo fiber skins, and performing drying treatment after the fermentation is completed; performing kneading, oiling and conditioning treatments on the dried bamboo fiber skins; performing combing and drawing treatments on the conditioned bamboo fiber skins; and zoning and storing.

### CROSS-REFERENCE TO RELATED APPLICATIONS

This application claims priority to Chinese Patent Application No. 202410748688.5, filed on Jun. 11, 2024, the contents of which are hereby incorporated by reference.

### TECHNICAL FIELD

The present disclosure belongs to the technical field of bamboo processing, and in particular relates to a preparation method for raw bamboo fiber strips and a processing machine.

### BACKGROUND

Original ecological long bamboo fiber has been applied in the fields of automobile interior and mattress core materials, providing a way for high-value utilization of bamboo wood. At present, natural bamboo fiber is usually obtained by softening bamboo wood and rolling, kneading and combing with a fiber opener. However, the fibers produced by this method usually have different lengths, uneven thickness, low fiber strength, rough shape, high ash content in powder, chemical pollution in the production process and are easy to brittle fracture, so the products may only be used to produce composite materials.

Therefore, there is a need to design a preparation method for raw bamboo fiber strips and a processing machine to solve the above problems.

### SUMMARY

An objective of the present disclosure is to provide a preparation method for raw bamboo fiber strips and a processing machine. Pure bamboo fiber strips are directly processed with fresh bamboo pieces, so that the produced fibers are soft, slender, high in strength and good in toughness.

In order to achieve the above objectives, the present disclosure provides the following solution: a preparation method for raw bamboo fiber strips, including following steps:
S1, cutting bamboo wood into bamboo tubes according to a length of each of bamboo joints, and cutting the bamboo tubes into bamboo pieces;
S2, processing each of the bamboo pieces into the bamboo fiber skins through a processing machine;
S3, performing fermentation treatment on the bamboo fiber skins, and performing drying treatment on the bamboo fiber skins after the fermentation treatment is completed;
S4, performing kneading, oiling and conditioning treatments on the bamboo fiber skins after the drying treatment;
S5, performing combing and drawing treatments on the bamboo fiber skins after the conditioning treatment; and
S6, zoning and storing.

In an embodiment, in the S1, the bamboo wood is selected from one or more of Sinocalamus affinis, Lingnania intermedia, Bambusa chungii, Bambusa textilis, Dendrocalamus membranaceus, Pseudosasa amabilis, Dendrocalamus latiflorus and Dendrocalamus sinicus; the length of each of the bamboo joints of the bamboo wood is 40 centimeters (cm) to 120 cm, and a width of each of the bamboo pieces is 2 cm to 2.5 cm.

In an embodiment, in the S2, a thickness of each of the bamboo fiber skins is 0.05 millimeter (mm) to 0.15 mm, and a number of the bamboo fiber skins produced from each of the bamboo pieces is 20 layers to 50 layers.

In an embodiment, in the S3, a softener is sprayed on the bamboo fiber skins, an amount of the softener is 95% to 100% of a mass of the bamboo fiber skins, and the bamboo fiber skins with the softener are put into a fermentation room for the fermentation treatment, a temperature in the fermentation room is 60° C. to 65° C., a relative humidity is 70% to 95%, and a fermentation duration is 7-15 days; after the fermentation treatment is completed, a belt drier is used to dry the bamboo fiber skins, and a moisture content of the dried bamboo fiber skins is 20%.

In an embodiment, a formula of the softener is: adding 4% to 5% of bamboo fiber alkaline pectinase to 100 kilograms (KG) of sodium hydroxide alkaline solution, and a PH of the sodium hydroxide alkaline solution is 10 to 10.5.

In an embodiment, in the S4, the kneading treatment is performed on the dried bamboo fiber skins, and after the kneading treatment is completed, a white oil emulsifier is used for oiling treatment; and after the oiling treatment is completed, the bamboo fiber skins are placed in a conditioning room for the conditioning treatment, and a conditioning duration is 5-13 days.

In an embodiment, the white oil emulsifier includes 3.5% of tea oil, 3% of polyethylene glycol-20 (PEG-20), 0.5% of polyethylene glycol-40 (PEG-40) and 93% of water; and a preparation method of the white oil emulsifier is: heating the tea oil to 60° C., adding the PEG-20 and the PEG-40, and stirring uniformly, heating the water to 80° C. and adding into a mixture of the tea oil, the PEG-20 and the PEG-40, stirring uniformly, and cooling to room temperature to obtain the white oil emulsifier.

In an embodiment, in the S5, the bamboo fiber skins are combed into fiber bundles by a hackling machine, the fiber bundles are made into fiber strips by a slivering machine, and the fiber strips are drawn and combed using a combing machine.

The processing machine used in the preparation method, including a processing table, where a connecting column is fixedly connected to a middle of a top end of one side wall of the processing table, and a vertical cylinder is fixedly connected to one side of the connecting column close to the processing table; a telescopic end of the vertical cylinder faces downwards and is fixedly connected to one end of each of two connecting rods horizontally arranged. Bottom ends of the two connecting rods are collectively fixedly connected with a cutter head, and a top end of the processing table is fixedly connected with a flat plate. a middle of a top end of the flat plate is fixedly connected with a guide rail. One end of the flat plate is fixedly connected with a fixed end of a horizontal cylinder through a fixing frame, and a telescopic end of the horizontal cylinder is fixedly connected with a sliding table, where the sliding table is slidably arranged at a top end of the guide rail. A top of one end of the sliding table close to the horizontal cylinder is detachably connected with a pressing plate through first bolts, and each of the bamboo pieces is clamped between the pressing plate and the sliding table, and the cutter head is in up-and-down correspondence with the bamboo piece.

In an embodiment, a bottom end of the cutter head is detachably connected with a blade through a wedge clamp, the wedge clamp is detachably connected with the bottom end of the cutter head through second bolts, and the cutter head is provided with a slicing outlet running through from top to bottom.

Compared with the prior art, the present disclosure has the following advantages and technical effects.

The present disclosure directly processes pure bamboo fiber strips with fresh bamboo pieces, and the prepared bamboo fiber strips are soft, slender, high in strength and good in toughness, and are suitable for making high-end textile fiber yarns and other products.

### BRIEF DESCRIPTION OF THE DRAWINGS

In order to explain the embodiments of the present disclosure or the technical solution in the prior art more clearly, the drawings needed in the embodiments will be briefly introduced below. Apparently, the drawings in the following description are only some embodiments of the present disclosure. For one of ordinary skill in the art, other drawings may be obtained according to these drawings without paying creative labor.

FIG. 1 is a schematic structural diagram of a processing machine according to the present disclosure.

FIG. 2 is a schematic structural diagram of a cutter head according to the present disclosure.

FIG. 3 is another schematic structural diagram of the cutter head according to the present disclosure.

FIG. 4 is a schematic diagram of a preparation method for raw bamboo fiber strips according to the present disclosure.

### DETAILED DESCRIPTION OF THE EMBODIMENTS

In the following, the technical solutions in the embodiments of the present disclosure will be clearly and completely described with reference to the attached drawings. Apparently, the described embodiments are only a part of the embodiments of the present disclosure, but not all the embodiments. Based on the embodiments in the present disclosure, all other embodiments obtained by one of ordinary skill in the art without creative effort belong to the protection scope of the present disclosure.

In order to make the above objects, features and advantages of the present disclosure more obvious and easier to understand, the present disclosure will be further described in detail with the attached drawings and specific embodiments.

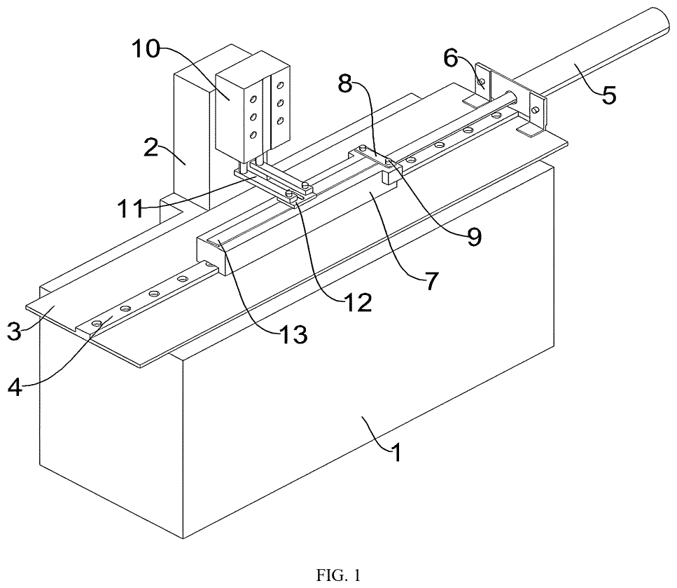

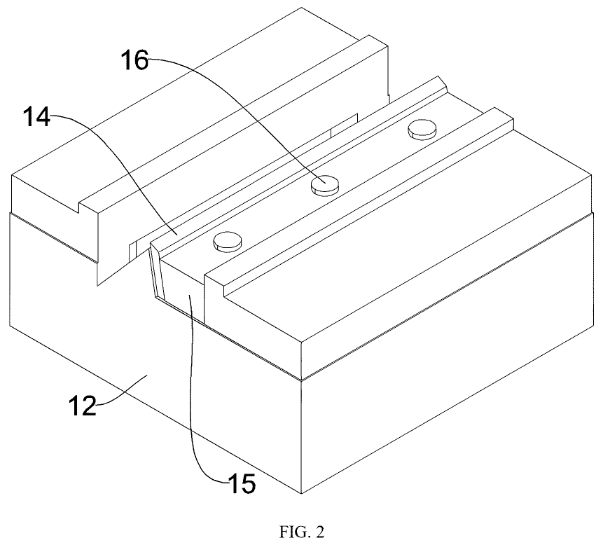

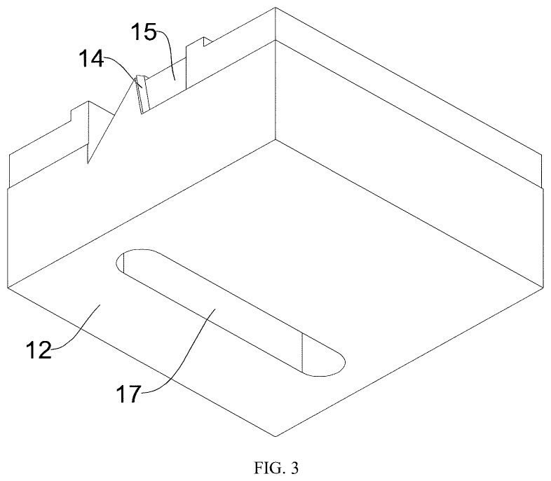

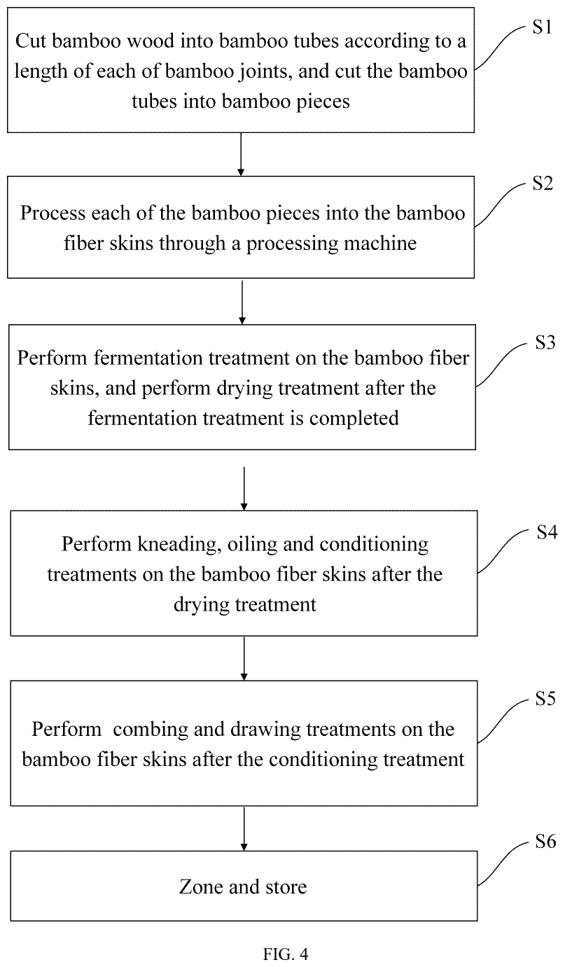

With reference to FIG. 1 to FIG. 4, the present disclosure provides a preparation method for raw bamboo fiber strips, including following steps:
S1, processing bamboo pieces: bamboo wood is cut into bamboo tubes according to the length of each bamboo joint, and then the bamboo tubes are cut into bamboo pieces;
S2, processing bamboo fiber skins: each of the bamboo pieces is processed into the bamboo fiber skins through a processing machine;
S3, fermenting and drying the bamboo fiber skins: fermentation treatment is performed on the processed bamboo fiber skins; and drying treatment performed on the bamboo fiber skins after the fermentation is completed;
S4, kneading, oiling and conditioning the bamboo fiber skins: kneading, oiling and conditioning treatments are performed on the dried bamboo fiber skins;
S5, combing and drawing the bamboo fiber skins: combing and drawing treatments are performed on the conditioned bamboo fiber skins; and
S6, zoning and storing: after the drawing treatment is completed, the bamboo fiber strips are classified, packaged and put in storage.

In an embodiment, in the S1, bamboo wood is selected from one or more of Sinocalamus affinis, Lingnania intermedia, Bambusa chungii, Bambusa textilis, Dendrocalamus membranaceus, Pseudosasa amabilis, Dendrocalamus latiflorus and Dendrocalamus sinicus. The length of each of bamboo joints of the bamboo wood is 40 cm to 120 cm, and the width of each of bamboo pieces is 2 cm to 2.5 cm.

The bamboo tubes are made into bamboo pieces by using a mechanical knocking table.

In an embodiment, in the S2, the thickness of each of bamboo fiber skins is 0.05 mm to 0.15 mm, and the number of bamboo fiber skins produced from each bamboo piece is 20-50 layers.

In an embodiment, in the S3, a softener is sprayed on the bamboo fiber skins, the amount of the softener is 95% to 100% of the mass of the bamboo fiber skins, and then the bamboo fiber skins with the softener are put into a fermentation room for fermentation, the temperature in the fermentation room is 60° C. to 65° C., the relative humidity is 70% to 95%, and the fermentation duration is 7-15 days. After the fermentation is completed, a belt drier is used to dry the bamboo fiber skins, and the moisture content of the dried bamboo fiber skins is 20%.

A fermentation tank may also be used for the fermentation treatment, and a temperature and humidity sensor is arranged in the fermentation room or the fermentation tank, and the temperature and humidity in the fermentation room or the fermentation tank are controlled by a hot steam actuator.

The softener is evenly sprayed on the bamboo fiber skins by using a sprayer and a rolling device.

In an embodiment, the formula of the softener includes: 4% to 5% of bamboo fiber alkaline pectinase is added to 100 KG of sodium hydroxide alkaline solution, and the PH of the sodium hydroxide alkaline solution is 10 to 10.5.

In an embodiment, in the S4, the kneading treatment is performed on the dried bamboo fiber skins, and after the kneading is completed, a white oil emulsifier is used for oiling treatment. After the oiling is completed, the bamboo fiber skins are placed in a conditioning room for the conditioning treatment, and the conditioning duration is 5 days to 13 days.

In an embodiment, the white oil emulsifier includes 3.5% of tea oil, 3% of PEG-20, 0.5% of PEG-40 and 93% of water. The preparation method of the white oil emulsifier includes the following steps: the tea oil is heated to 60° C., the PEG-20 and the PEG-40 are added, and stirred evenly; and the water is heated to 80° C. and then added into the mixture of the tea oil, the PEG-20 and the PEG-40, the mixture is stirred evenly, and cooled to room temperature to obtain the white oil emulsifier.

In an embodiment, in the S5, the bamboo fiber skins are combed into fiber bundles by a hackling machine, then the fiber bundles are made into fiber strips by a slivering machine, and then the fiber strips are drawn and combed using a combing machine.

Scraps produced in the combing process may be further opened up and combed to produce bamboo fiber strips, and the drawing and combing process is carried out for 7 times, which may make bamboo fiber strips thinner and more uniform.

A processing machine used in the preparation method for raw bamboo fiber strips, includes a processing table 1, a connecting column 2 is fixedly connected to the middle of the top end of one side wall of the processing table 1. A vertical cylinder 10 is fixedly connected to one side of the connecting column 2 close to the processing table 1, the telescopic end of the vertical cylinder 10 faces downwards and is fixedly connected to one end of each of two horizontally arranged connecting rods 11. Bottom ends of the two connecting rods 11 are collectively fixedly connected with a cutter head 12, and the top end of the processing table 1 is fixedly connected with a flat plate 3; the middle of the top end of the flat plate 3 is fixedly connected with a guide rail 4. One end of the flat plate 3 is fixedly connected with the fixed end of a horizontal cylinder 5 through a fixing frame 6, and the telescopic end of the horizontal cylinder 5 is fixedly connected with a sliding table 7. The sliding table 7 is slidably arranged at the top end of the guide rail 4, and the top of one end of the sliding table 7 close to the horizontal cylinder 5 is detachably connected with a pressing plate 8 through first bolts 9. The bamboo piece 13 is clamped between the pressing plate 8 and the sliding table 7, and the cutter head 12 is in up-and-down correspondence with the bamboo piece 13.

In an embodiment, the bottom end of the cutter head 12 is detachably connected with a blade 14 through a wedge clamp 15, the wedge clamp 15 is detachably connected with the bottom end of the cutter head 12 through second bolts 16, and the cutter head 12 is provided with a slicing outlet 17 running through from top to bottom.

The blade 14 is clamped in the cutter head 12 by the wedge clamp 15, and the position of the blade 14 may be adjusted by the wedge clamp 15 through the dial indicator.

In order to create creases in the sliced bamboo fiber skins, there is a need to position the slicing angle of the blade 14 at an angle of 15° to 85° with the sliced section of bamboo fiber skins. The blade 14 may be a disposable alloy blade or a reusable wear-resistant blade.

The working process of the processing machine is as follows.
S1, lifting the cutter head 12: the vertical cylinder 10 is started to lift the cutter head 12, providing conditions for the processing of the bamboo piece 13.
S2, clamping the bamboo piece 13: the bamboo piece 13 is laid flat on the sliding table 7, so that one end of bamboo piece 13 is clamped between the sliding table 7 and the pressing plate 8, and the other end is directly below the cutter head 12. When the bamboo piece 13 is clamped, the bamboo green surface faces upward and the bamboo yellow surface faces downward, and the clamping end of the bamboo piece 13 exceeds the end of the sliding table 7 by 0.5 cm to 1 cm.
S3, operating the horizontal cylinder 5: the switch of the horizontal cylinder 5 is turned on, so that the telescopic end of the horizontal cylinder 5 pushes the sliding table 7 to move close to the cutter head 12, and at this time, the cutter head 12 is close to the clamping end of the bamboo piece 13 clamped between the pressing plate and the sliding table.
S4, putting down the cutter head 12: the vertical cylinder 10 is controlled to put down the cutter head 12, and the cutter head 12 is placed on the processing surface of the bamboo piece 13, and the pressing force is controlled by the air pressure, and then the horizontal cylinder 5 is started to enable the telescopic end of the horizontal cylinder 5 to return to the original position. When the clamping end of the bamboo piece 13 passes through the cutter head 12, the blade 14 begins to slice the bamboo piece 13 until all the exposed bamboo piece 13 is sliced, and the sliced bamboo fiber skins slide out of the slicing outlet 17. The telescopic end of the horizontal cylinder 5 pushes the sliding table 7 to move until the sliding table 7 touches the travel switch. At this time, the bamboo piece 13 is continuously sliced into complete bamboo fiber skins by the blade 14.
S5, the telescopic end of the horizontal cylinder 5 returns to the original position: the horizontal cylinder 5 returns the telescopic end to the original position through the air pressure control loop.
S6, the above steps 1 to 5 are repeated. A single bamboo piece may be sliced into 20-50 layers of bamboo fiber skins.

### EXPERIMENTAL EXAMPLE

Two-year-old Bambusa textilis is taken, and bamboo joints are removed, and bamboo tubes are sliced into bamboo pieces 13 with a width of 2 cm to 3.5 cm by an impact knocking table, and the moisture content of the bamboo pieces 13 is 45% to 48%. The vertical cylinder 10 is turned on, the cutter head 12 is lifted, so that the bamboo piece 13 is laid flat on the sliding table 7 and the bamboo piece 13 is clamped between the pressing plate 8 and the sliding table 7, one end of the bamboo piece 13 protrudes from the end of the pressing plate 8 by 0.5 cm to 1 cm, and the other end of the bamboo piece 13 is located below the cutter head 12. The horizontal cylinder 5 is started, so that that telescopic end of the horizontal cylinder 5 pushes the sliding table 7 to move close to the cutter head 12, and at this time, the cutter head 12 is adjacent to the clamping end of the bamboo piece 13. The vertical cylinder 10 is controlled to put down the cutter head 12, and the cutter head 12 is placed on the processing surface of the bamboo piece 13, and the pressing force is controlled by the air pressure, and then the switch of the horizontal cylinder 5 is started to return the telescopic end of the horizontal cylinder 5 to the original position. When the clamping end of the bamboo piece 13 passes through the cutter head 12, the blade 14 begins to slice the bamboo piece 13 until all the exposed bamboo piece 13 is sliced, and the sliced bamboo fiber skins slide out of the slicing outlet 17. The thickness of the sliced bamboo fiber skins is 0.05 mm to 0.15 mm, and the sliced thickness may be changed by adjusting the cutter head 12. By repeating the above process, 20 layers to 50 layers of bamboo fiber skins may be sliced.

Bamboo fiber bundles may be processed on a large scale by the above methods. Subsequent processing procedures include fermentation, drying, oiling, conditioning, combing into strips by the hackling machine, combing by the comber, drawing and so on. Thus, the original ecological bamboo fiber strips may be obtained. After packaging, the bamboo fiber strips are put into storage for sale to textile enterprises for further processing into yarns and fabrics.

In the description of the present disclosure, it should be understood that the terms “longitudinal”, “transverse”, “up”, “down”, “front”, “back”, “left”, “right”, “vertical”, “horizontal”, “top”, “bottom”, “inside”, “outside”, etc. indicate orientation or positional relationships based on the orientation or positional relationships shown in the accompanying drawings, only for the convenience of describing the present disclosure, and do not indicate or imply that the device or element referred to must have a specific orientation, be constructed and operated in a specific orientation, and therefore cannot be understood as a limitation of the present disclosure.

The above-mentioned embodiments only describe the preferred mode of the present disclosure, and do not limit the scope of the present disclosure. Under the premise of not departing from the design spirit of the present disclosure, various modifications and improvements made by on of ordinary skill in the art to the technical solution of the present disclosure should fall within the protection scope of the present disclosure.

What is claimed is:

1. A preparation method for raw bamboo fiber strips, comprising following steps:
S1, cutting bamboo wood into bamboo tubes according to a length of each of bamboo joints, and cutting the bamboo tubes into bamboo pieces;
S2, processing each of the bamboo pieces into the bamboo fiber skins through a processing machine;
S3, performing fermentation treatment on the bamboo fiber skins, and performing drying treatment on the bamboo fiber skins after the fermentation treatment is completed;
S4, performing kneading, oiling and conditioning treatments on the bamboo fiber skins after the drying treatment;
S5, performing combing and drawing treatments on the bamboo fiber skins after the conditioning treatment; and
S6, zoning and storing.

2. The preparation method according to claim 1, wherein in the S1, the bamboo wood is selected from one or more of Sinocalamus affinis, Lingnania intermedia, Bambusa chungii, Bambusa textilis, Dendrocalamus membranaceus, Pseudosasa amabilis, Dendrocalamus latiflorus and Dendrocalamus sinicus; the length of each of the bamboo joints of the bamboo wood is 40 cm to 120 cm, and a width of each of the bamboo pieces is 2 cm to 2.5 cm.

3. The preparation method according to claim 1, wherein in the S2, a thickness of each of the bamboo fiber skins is 0.05 mm to 0.15 mm, and a number of the bamboo fiber skins produced from each of the bamboo pieces is 20-50 layers.

4. The preparation method according to claim 1, wherein in the S3, a softener is sprayed on the bamboo fiber skins, an amount of the softener is 95% to 100% of a mass of the bamboo fiber skins, and the bamboo fiber skins with the softener are put into a fermentation room for the fermentation treatment, a temperature in the fermentation room is 60° C. to 65° C., a relative humidity is 70% to 95%, and a fermentation duration is 7-15 days; and after the fermentation treatment is completed, a belt drier is used to dry the bamboo fiber skins, and a moisture content of the dried bamboo fiber skins is 20%.

5. The preparation method according to claim 4, wherein a formula of the softener is: adding 4% to 5% of bamboo fiber alkaline pectinase to 100 KG of sodium hydroxide alkaline solution, and wherein a PH of the sodium hydroxide alkaline solution is 10 to 10.5.

6. The preparation method according to claim 1, wherein in the S4, the kneading treatment is performed on the dried bamboo fiber skins, and after the kneading treatment is completed, a white oil emulsifier is used for oiling treatment; and after the oiling treatment is completed, the bamboo fiber skins are placed in a conditioning room for the conditioning treatment, and a conditioning duration is 5-13 days.

7. The preparation method according to claim 6, wherein the white oil emulsifier comprises 3.5% of tea oil, 3% of PEG-20, 0.5% of PEG-40 and 93% of water; and a preparation method of the white oil emulsifier comprises: heating the tea oil to 60° C., adding the PEG-20 and the PEG-40, and stirring uniformly, heating the water to 80° C. and adding into a mixture of the tea oil, the PEG-20 and the PEG-40, stirring uniformly, and cooling to room temperature to obtain the white oil emulsifier.

8. The preparation method according to claim 1, wherein in the S5, the bamboo fiber skins are combed into fiber bundles by a hackling machine, the fiber bundles are made into fiber strips by a slivering machine, and the fiber strips are drawn and combed using a combing machine.

9. A processing machine used in the preparation method according to claim 1, comprising: a processing table, wherein a connecting column is fixedly connected to a middle of a top end of one side wall of the processing table, and a vertical cylinder is fixedly connected to one side of the connecting column close to the processing table; a telescopic end of the vertical cylinder faces downwards and is fixedly connected to one end of each of two connecting rods horizontally arranged, and bottom ends of the two connecting rods are collectively fixedly connected with a cutter head; a top end of the processing table is fixedly connected with a flat plate, a middle of a top end of the flat plate is fixedly connected with a guide rail; one end of the flat plate is fixedly connected with a fixed end of a horizontal cylinder through a fixing frame, a telescopic end of the horizontal cylinder is fixedly connected with a sliding table, and the sliding table is slidably arranged at a top end of the guide rail; and a top of one end of the sliding table close to the horizontal cylinder is detachably connected with a pressing plate through first bolts, and each of the bamboo pieces is clamped between the pressing plate and the sliding table, and the cutter head is in up-and-down correspondence with the bamboo piece.

10. The processing machine used for the preparation method according to claim 9, wherein a bottom end of the cutter head is detachably connected with a blade through a wedge clamp, the wedge clamp is detachably connected with the bottom end of the cutter head through second bolts, and the cutter head is provided with a slicing outlet running through from top to bottom.
